(19) United States
(12) Patent Application Publication
(10) Pub. No.: US 2004/0237429 A1
(43) Pub. Date: Dec. 2, 2004

(54) Conservatory roof structures, glazing bar upper covers & glazing bars therefor

(76) Inventor: Barry McMahon, Blackburn (GB)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/480,555

(22) PCT Filed: Jun. 12, 2002
(86) PCT No.: PCT/GB02/02692

(30) Foreign Application Priority Data
Jun. 12, 2001 (GB) 0114254.6

(51) Int. Cl. E06B 1/04; E06B 3/00

(52) U.S. Cl. 52/204.1; 52/204.5

(57) ABSTRACT

According to the present invention there is disclosed a glazing bar upper cover (70) for use at an angle to the horizontal on a conservatory roof, which glazing bar upper cover comprises a first vent and a second vent (86), the first and second vents (86) providing, in use, a vent from one side to the other of the glazing bar upper cover wherein the first vent is spaced from the second vent along the length of the glazing bar upper bar.

### FIELD OF THE INVENTION

The present invention relates to glazing bar upper covers, glazing bars incorporating such upper covers, conservatory roof structures and to methods of producing-such glazing bar upper covers.

### BACKGROUND TO THE INVENTION

In a conservatory roof-structure, glazing bars are provided with a plurality of hips extending from a central ridge. The glazing bars are generally chambered aluminium metal extrusions which are known to be covered both internally and externally by means of polyvinyl chloride (PVC) formed extrusions. Such assemblies in a complete state are known as glazing bars with the whole comprehensive assembly forming a generally hollow section along a length in profile. The aforementioned polyvinyl chloride (PVC) covers suitably provide both aesthetically pleasing and thermal cladding to the otherwise exposed metal as well as to clamp panels within the roof structure which may be fluted polycarbonate sheeting, glazed units or other similar glazing elements. The glazing bars are subject to a number of environmental factors from the weather and environment maintained within the conservatory by the owner. It has been found that the temperature variation induced in the glazing bars can cause deformations thereof which are unsightly for the owners who require repair thereof. The thermal problems are exacerbated in the hip bars due to the physical stresses they endure, and even more so when an external laminate is applied to the glazing bar, in particular because of the different rates of expansion of the PVC glazing bar and laminate when compared with the intervening adhesive.

In known glazing bars for use at an angle to the horizontal on a conservatory roof, there is no provision for venting for the purpose of cooling. The only proposals for having other then closed ends are for water drainage.

It is an aim of preferred embodiments of the present invention to obviate or overcome a problem of the prior is art, whether referred to herein or otherwise.

### SUMMARY OF THE INVENTION

According to the present invention in a first aspect, there is provided a glazing bar upper cover for use at an angle to the horizontal on a conservatory roof, which glazing bar upper cover comprises a first vent and a second vent, the first and second vents providing, in use, a vent from one side to the other of the glazing bar upper cover wherein the first vent is spaced from the second vent along the length of the glazing bar upper bar.

An upper cover is intended, in use, to form the upper covering of a glazing bar.

Suitably, a vent is at an end of the glazing bar upper cover.

Suitably, the glazing bar comprises at least one cooling fin on the inside thereof, typically on a glazing bar upper cover. Suitably the glazing bar comprises a body portion and an upper cover, wherein the at least one cooling fin is located on the upper cover. Suitably, a plurality of cooling fins is provided. Suitably, the cooling fins comprise a plurality of elongate protrusions from the inside of the upper cover.

According to the present invention in a third aspect, there is provided a glazing bar for a conservatory roof, which glazing bar comprises at least one cooling fin on the inside thereof.

Suitably, the cooling fins comprise a plurality of elongate protrusions from the inside of the upper cover.

Suitably, the glazing bar comprises a hollow section having a length, and comprises a glazing bar upper cover at least partly defining an interior comprising a first vent and a second vent, the first and second vents providing a vent from the interior to outside the glazing bar upper cover wherein the first vent is spaced from the second vent along the length of the glazing bar upper cover.

Suitably, a vent is at an end of the glazing bar upper cover. Suitably, the vent is in an end cap of the glazing bar.

Suitably, the glazing bar is a hip bar.

The glazing bar may be laminated. Suitably, the laminate consists of a PVC material.

Suitably, the glazing bar consists of a PVC material. Suitably, the glazing bar is an extrudate.

Suitably, the vent comprises a hole in the glazing bar upper cover. Suitably, the hole is an elongate hole. Suitably, the hole provides an air flow path from the inside of the glazing bar to the outside thereof.

Suitably, a cover is provided partly over the hole. Suitably, the cover comprises a cap with an open portion locatable, in use, on the glazing bar upper cover whereby the open portion is at the bottom. Suitably, the cover snap-fits to the glazing bar upper cover.

Suitably the glazing bar comprises a body portion and an upper cover, wherein the at least one cooling fin is located on the upper cover.

Typically, the cooling fin is on a glazing bar upper cover.

According to the present invention in a fourth aspect, there is provided a conservatory roof structure comprising a glazing bar according to the second or third aspects of the invention, which glazing bar is at an angle to the horizontal.

Suitably, the glazing bar is mounted in a ridge end.

Suitably, the ridge end is vented. Suitably, the ridge end is vented whereby air can flow from inside the conservatory to outside.

According to the present invention in a fifth aspect, there is provided a method of producing a glazing bar upper cover according to the first aspect of the invention, the method comprising the steps of inserting a first vent and a second vent in a glazing bar to produce a glazing bar according to the first aspect of the present invention.

### BRIEF DESCRIPTION OF THE DRAWINGS

The present invention will now be described, with reference to the drawings that follow; in which:

FIGS. 1 and 2 are plan views of two conservatory roof structures according to embodiments of the present invention.

FIG. 3 is a perpendicular cross-section of a glazing bar of FIG. 1.

FIG. 4 is an exploded perspective view of a glazing bar cap and hole covers from FIG. 3.

FIGS. 5A and 5B are enlarged perspective views of the hole covers from FIGS. 3 and 4.

FIG. 6 is a perpendicular cross-section of a ridge end of FIG. 1.

FIG. 7 is a perspective view of an inverted ridge cover from FIG. 6.

FIG. 8 is a perpendicular cross-section of a further glazing bar according to an embodiment of the present invention.

FIGS. 9-11 are graphs illustrating the variation in temperature along glazing bars with time for a white bar, a mahogany laminated bar and a vented bar respectively.

### DESCRIPTION OF THE PREFERRED EMBODIMENTS

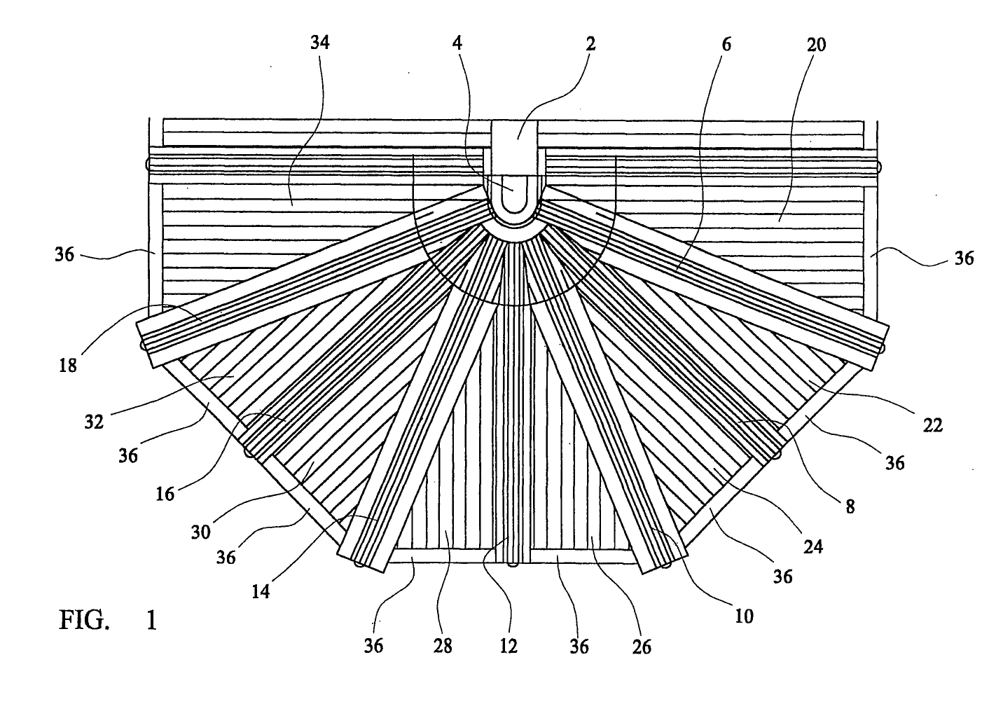

FIG. 1 is a plan view of a Victorian style conservatory roof structure comprising a ridge 2, a ridge end 4, hip rafters 6-18 and glazing panels 20-34. The hip rafters 6-18 extend from ridge end 4 at an angle to the horizontal to eaves 36 and are formed from extruded PVC covered glazing bars as described below.

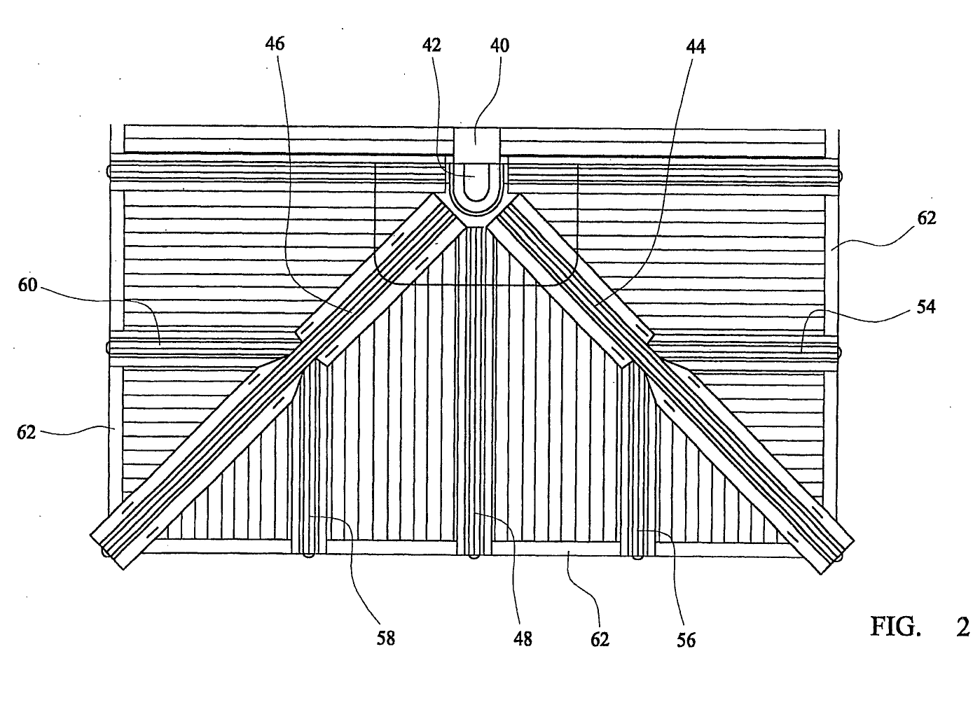

FIG. 2 is a plan view of a Georgian style conservatory roof structure comprising a ridge 40, a ridge end 42, hip rafters 44, 46, 48 and jack rafters 54-60. The hip rafters 44-52 extend from ridge end 42 at an angle to the horizontal to eaves 62 and are formed from PVC glazing bars as described below.

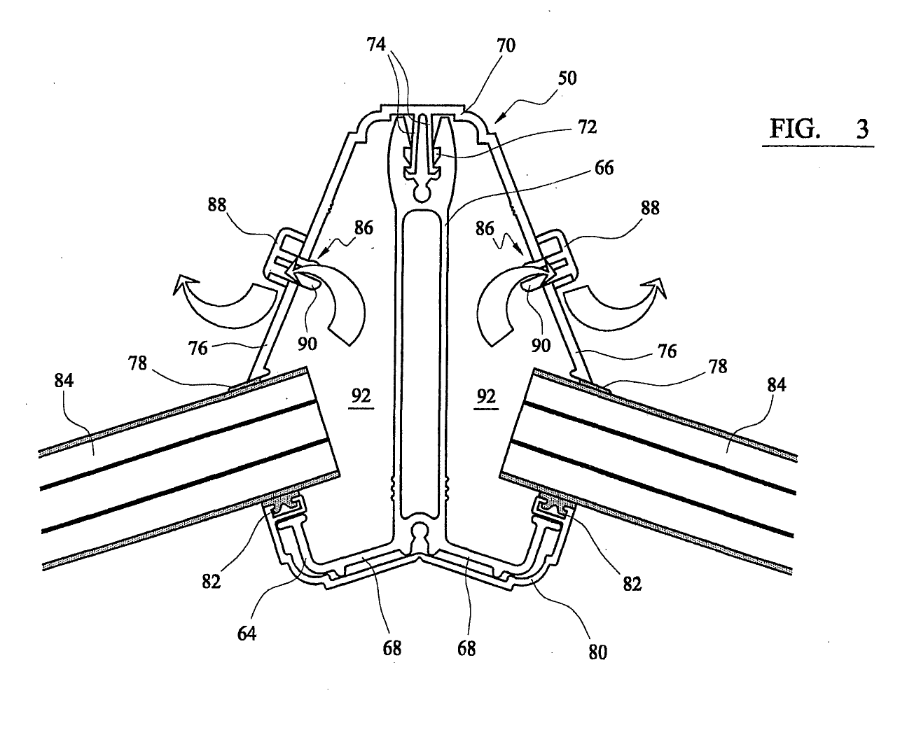

FIG. 3 shows a cross-section of a glazing bar (hip bar) 50 of hip rafter 6 by way of example, comprising an inverted T-shaped central body 64 having an upstanding portion 66 and legs 68. An n-shaped glazing bar upper cover or rafter cap 70 is snap fit into a recess 72 in the top of the upstanding portion 66 using corresponding opposed resilient rebated fingers 74 (see also FIG. 4). These hinges 74 form means for attachment of the upper case 70 to another part (in this case upstanding portion 66) of a glazing bar. Depending legs 76 of upper cover cap 70 each terminate in plastics gasket 78. A lower cap 80 connects round legs 68 of central body 64, which lower cap 80 carries plastics gasket 82 in channels thereof. Hip bar 50 holds glazing elements 84, such as a double glazing panel on either side thereof between corresponding gaskets 78, 82.

Approximately mid-way up depending legs 76 of upper cover 70 are vent holes 86 in which are snap fitted weather covers 88.

External surfaces of the bar 50 may be laminated (not shown). A PVC laminate is glued to the bar 50 by a silicone-free hot-melt adhesive.

Referring in particular to FIG. 4 of the drawings that follow, a vent hole 86 can be seen to be an elongate round ended hole. The covers 88 are of a corresponding shape with rebated resilient fingers 90 for a snap-fit connection in vent holes 86. The covers 88 surround the holes 86 when in place, but have a cut-away lower section 93 to enable air to enter or egress from the hollow inside 92 of hip bar 50 (egress is shown by arrows in FIG. 3), but be small enough to prevent rain and insects entering.

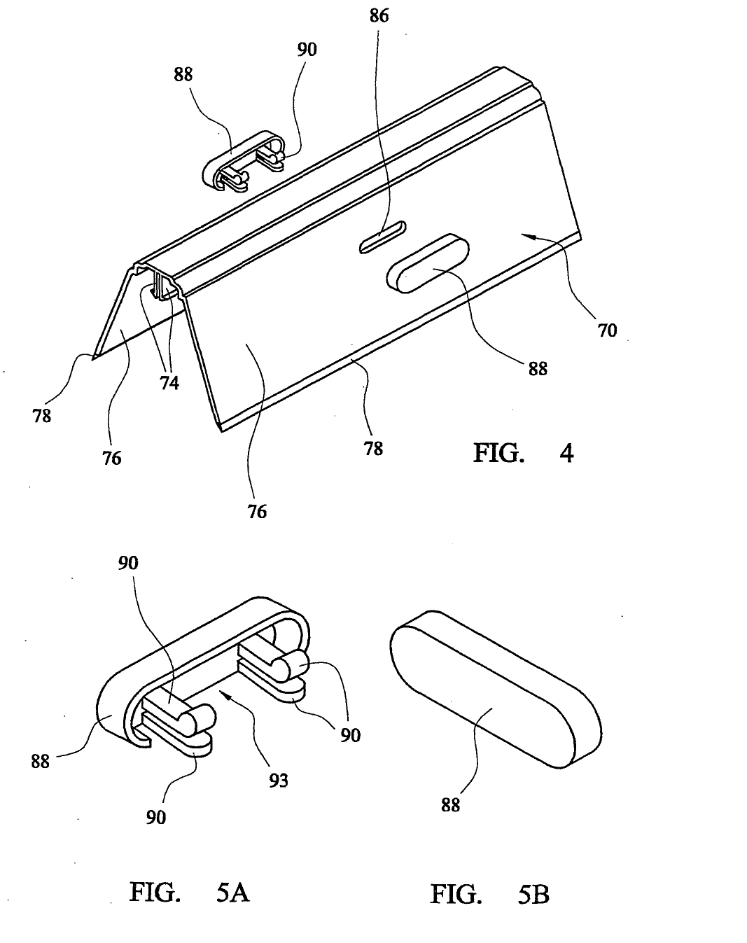

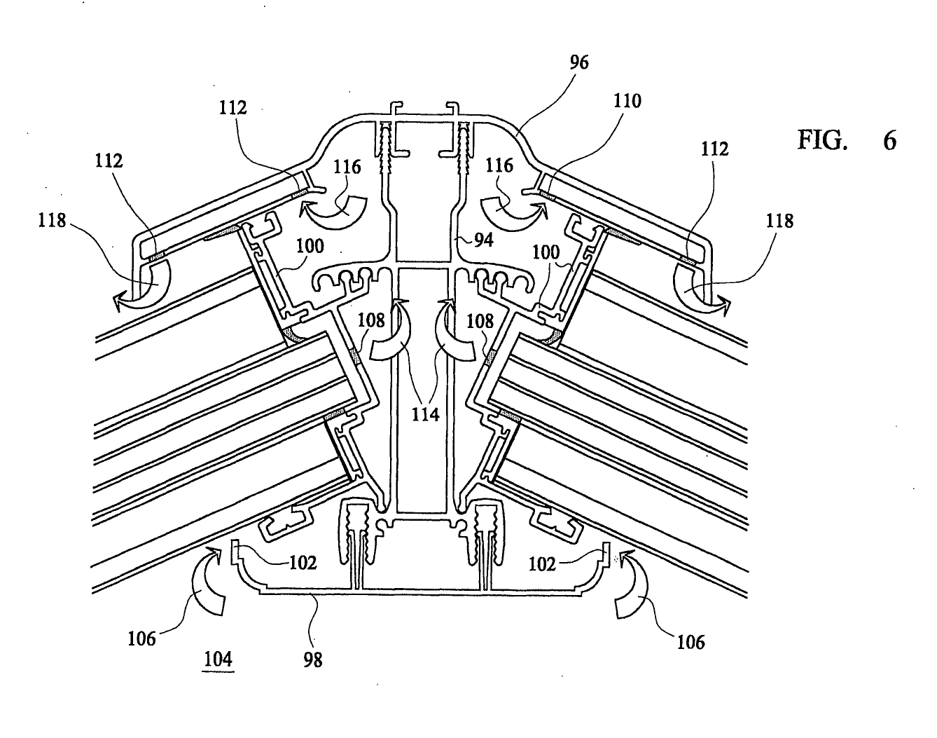

The covers 88 are shown in more detail in FIGS. 5A and 5B of the drawings that follow.

Referring back to FIGS. 1 and 2 the vent hole 86 locations are shown. Each vent hole 86 is approximately 100 mm from the end of centrepoint of the respective glazing bar.

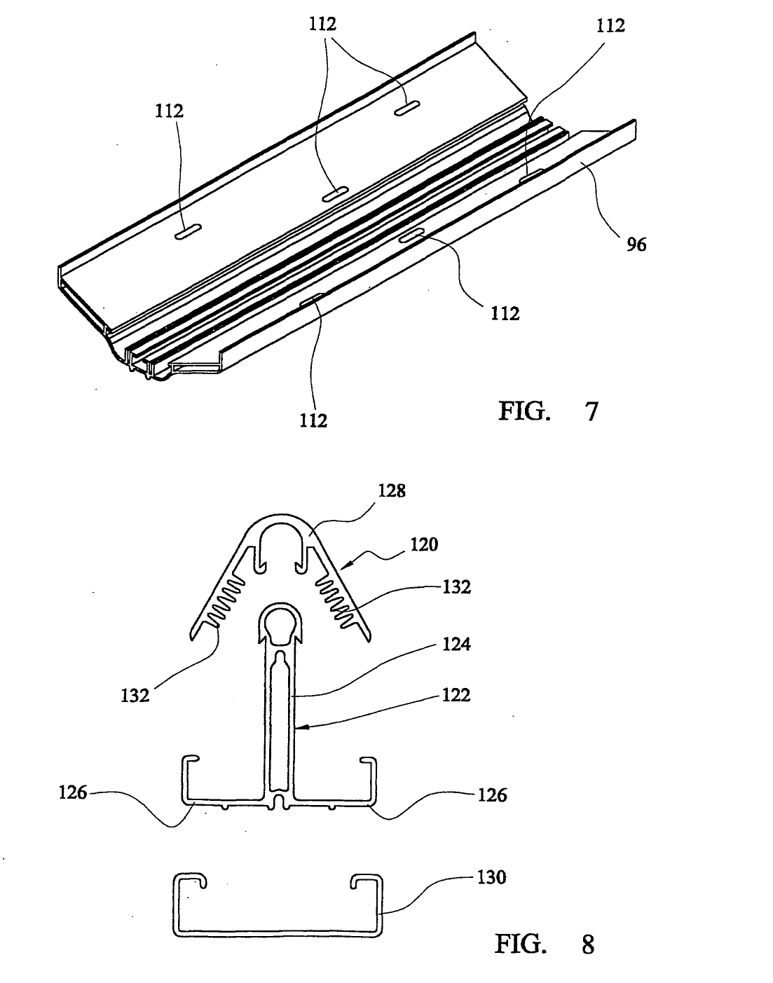

Referring to FIGS. 6 and 7 of the drawings that follow, the hip bar 50 terminates and is mounted in ridge end 4. Ridge end 4 comprises a central mounting structure 94 to which is attached a glazing bar upper cover 96 (See FIG. 7), a lower cap 98 and hip rafter connectors 100. The main function of lower cap 98 is to provide an aesthetically pleasing appearance to the interior of the conservatory. The upper cover 96 serves the same function as well as acting as a weather cover. Rafter connectors 100 provide means for mounting the glazing bars, being hip rafter 6 to the ridge. In a conservatory roof structure known methods of mechanically fixing said hip rafters 6 to a ridge assembly at the ridge end 4 are used.

Ends 102 of lower cover 96 do not seal against hip rafters 6, thus providing venting of the ridge end 4 from and to the interior 104 of the conservatory (as shown by arrows 106). Vent holes 108 in hip rafter connectors 100 and vent holes 110, 112 in upper cover 96 provide ventilation to the exterior environment as shown by arrows 114, 116, 118. Vent holes 108 are provided at an intended upper end of the rafter.

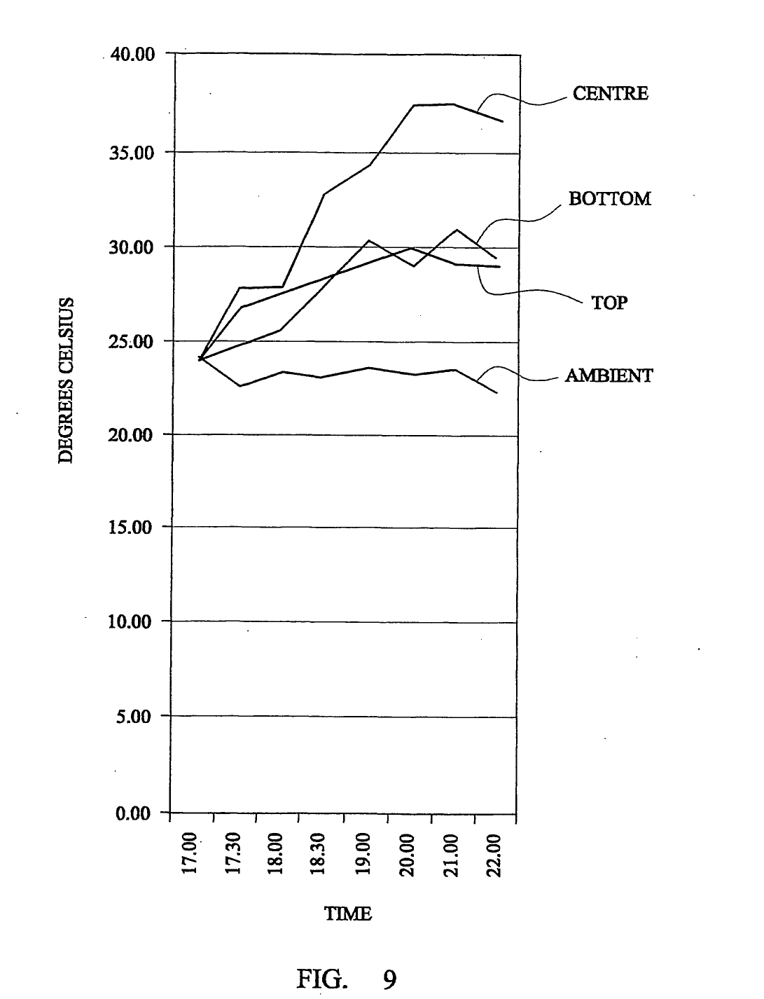

Referring to FIG. 8 of the drawings that follow, there is shown a cross-sectional view of an alternative glazing bar 120 comprising, as with hip bar 50, an inverted T-shaped central body 122 having an upstanding portion 124 and legs 126, an n-shaped rafter cap upper cover 128 and a lower cap 130. FIG. 8 shows a modification to hip bar 50 comprising a plurality of cooling fins 132 longitudinally along the hip bar 120 disposed on the inside of the upper cover 128. The cooling fins 132 comprise elongate projections from the inside of upper cover 128. In this example the finds 132 are parallel and are part of the same extrudate as upper cover 128. The cooling fins 132 increase the cooling of and general heat transfer from hip bar 120.

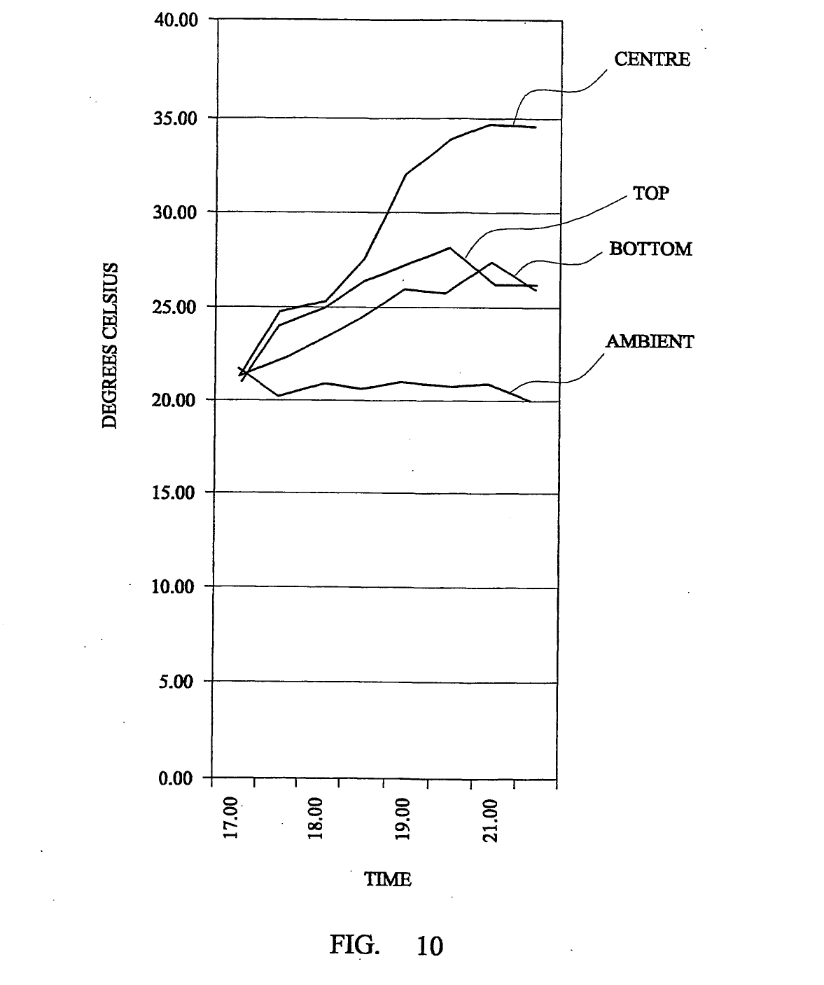

FIGS. 9-11 of the drawings that follow show the results of tests on three hip bars of the type shown in FIG. 3.

In each case sample bars of 1 metre length were made to top and bottom caps fitted to a Georgian hip (ridge end) and end caps fitted to either end. The bars were then sealed with adhesive tape to replicate the effect of glazing panels.

The bars were drilled with access holes at 50 mm from each end and at the centre. These were then taped over. The bars were arranged at a slope of 30° to the horizontal. Measurements were taken by a thermocouple inserted through the access holes to measure the temperature of air in the bars. The thermocouple was not allowed to touch the aluminium or PVC components. After the measurements, the holes were re-sealed with tape. A 1000 Watt lamp was placed over the bars at a range of 1 metre for 1 hour. The lamp was at 45° to the horizontal (simulating 3 pm on a Summer afternoon). After 90 minutes, the lamp was moved to 500 mm. Regular measurements were made of the temperature at the access holes.

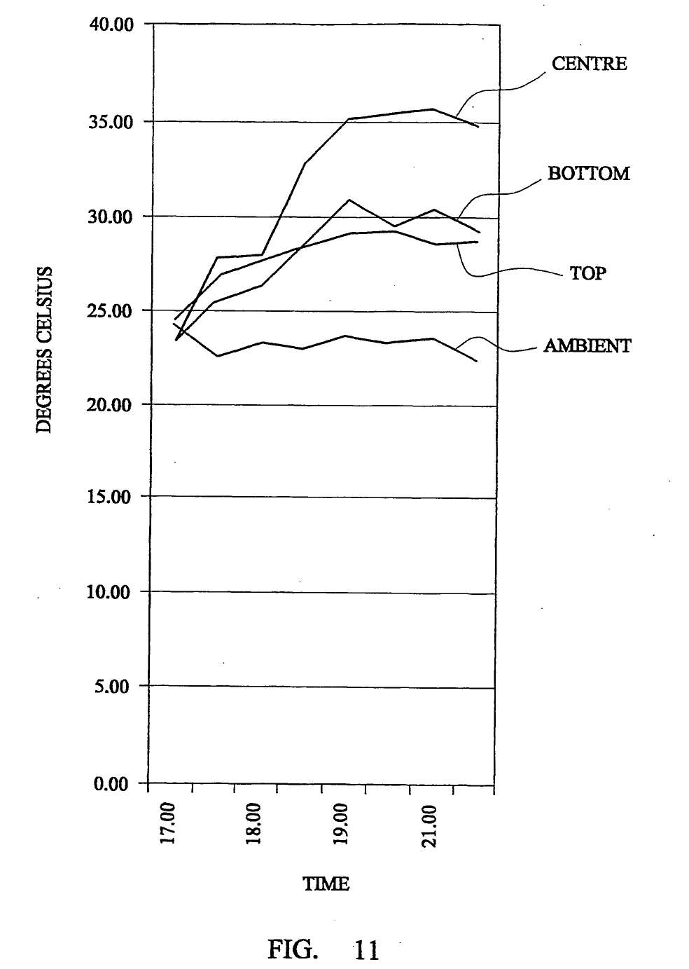

FIG. 9 shows the temperature measurements for a plain PVC white bar, FIG. 10 a mahogany laminated bar and FIG. 11 a plastic mahogany effect laminated bar with vents as shown above. It can be seen from FIGS. 9-11 that at least in the central and top sections the temperatures, and in particular the maximum temperatures, are substantially reduced. It is believed that this is sufficient to at least reduce the problems encountered with thermal effects without the vents.

In an alternative embodiment, one or more vents may be provided at the eaves end of the hip bar. This can be accomplished by providing a slot in the end cap of the glazing bar. If the ridge end is vented, vents in the glazing bar may be provided at either end thereof with a vent path from the end of the glazing bar to the vented area of the ridge end.

The vent holes may be provided at manufacture, during assembly, during fitting or as a retrofit. After manufacture, vent holes may be drilled or stamped out.

The number and spacing of the vents may vary.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A glazing bar upper cover for use at an angle to the horizontal on a conservatory roof, which glazing bar upper cover comprises a first vent and a second vent, the first and second vents providing, in use, a vent from one side to the other of the glazing bar upper cover wherein the first vent is spaced from the second vent along the length of the glazing bar upper bar.

2. A glazing bar upper cover according to claim 1, in which a vent is at an end of the glazing bar upper cover.

3. A glazing bar upper cover according to claim 1, in which a vent comprises a hole in the glazing bar upper cover.

4. A glazing bar upper cover according to claim 3, in which the hole is an elongate hole.

5. A glazing bar upper cover according to claim 4, in which the hole is spaced from the end of the glazing bar upper cover.

6. A glazing bar upper cover according to claim 3, in which a cover is provided partly over the hole.

7. A glazing bar upper cover according to claim 6, in which the cover comprises a cap with an open portion locatable, in use, on the glazing bar upper cover whereby the open portion is at the bottom.

8. A glazing bar upper cover according to claim 6, in which the cover snap-fits to the glazing bar.

9. A glazing bar upper cover according to claim 1, in which a plurality of vents are provided by holes.

10. A glazing bar upper cover according to claim 1, in which the glazing bar upper cover comprises means for attachment to another part of a glazing bar.

11. A glazing bar comprising a glazing bar upper cover according to claim 1.

12. A glazing bar according to claim 11, in which the glazing bar is a hip bar.

13. A glazing bar according to claim 11, in which the vent is in an end cap of the glazing bar.

14. A glazing bar according to claim 11, in which the glazing bar upper cover is laminated.

15. A glazing bar according to claim 14, in which the laminate consists of a PVC material.

16. A glazing bar according to claim 11, in which the glazing bar consists of a PVC material.

17. A glazing bar according to claim 11, in which the glazing bar upper cover is an extrudate.

18. A glazing bar according to claim 11, in which the glazing bar comprises at least one cooling fin on the inside thereof, typically on a glazing bar upper cover.

19. A glazing bar according to claim 18, in which the glazing bar comprises a body portion and an upper cover, wherein the at least one cooling fin is located on the upper cover.

20. A glazing bar according to claim 18 or claim 19, in which a plurality of cooling fins is provided.

21. A glazing bar according to claim 18, in which the cooling fins comprise a plurality of elongate protrusions from the inside of the upper cover.

22. A glazing bar for a conservatory roof, which glazing bar comprises at least one cooling fin on the inside thereof.

23. A glazing bar for a conservatory roof according to claim 22, in which the cooling fins comprise a plurality of elongate protrusions from the inside of the upper cover.

24. A glazing bar for a conservatory roof according to claim 22, in which the glazing bar comprises a hollow section having a length, and comprises a glazing bar upper cover at least partly defining an interior comprising a first vent and a second vent, the first and second vents providing a vent from the interior to outside the glazing bar upper cover wherein the first vent is spaced from the second vent along the length of the glazing bar upper cover.

25. A glazing bar for a conservatory roof according to claim 24, in which a vent is at an end of the glazing bar upper cover.

26. A glazing bar for a conservatory roof according to claim 25, in which the vent is in an end cap of the glazing bar.

27. A glazing bar for a conservatory roof according to claim 24, in which the glazing bar is a hip bar.

28. A glazing bar for a conservatory roof according to claim 24, in which the glazing bar is laminated.

29. A glazing bar for a conservatory roof according to claim 28, in which the laminate consists of a PVC material.

30. A glazing bar for a conservatory roof according to claim 24, in which the glazing bar consists of a PVC material.

31. A glazing bar for a conservatory roof according to claim 24, in which the glazing bar is an extrudate.

32. A glazing bar for a conservatory roof according to claim 24, in which the glazing bar comprises a body portion and an upper cover, wherein the at least one cooling fin is located on the upper cover.

33. A glazing bar for a conservatory roof according to claim 32, in which the cooling fin is on a glazing bar upper cover.

34. A conservatory roof structure comprising a glazing bar according to claim 11, which glazing bar is at an angle to the horizontal.

35. A conservatory roof structure comprising a glazing bar according to claim 34, in which the glazing bar is mounted in a ridge end.

36. A conservatory roof structure comprising a glazing bar according to claim 35, in which the ridge end is vented.

37. A conservatory roof structure comprising a glazing bar according to claim 36, in which the ridge end is vented whereby air can flow from inside the conservatory to outside.

38. (canceled)

39. A conservatory roof structure comprising a glazing bar according to claim 22, which glazing bar is at an angle to the horizontal.

40. A conservatory roof structure comprising a glazing bar according to claim 39, in which the glazing bar is mounted in a ridge end.

41. A conservatory roof structure comprising a glazing bar according to claim 40, in which the ridge end is vented.

42. A conservatory roof structure comprising a glazing bar according to claim 41, in which the ridge end is vented whereby air can flow from inside the conservatory to outside.

43. A method of producing a glazing bar upper cover according to the first aspect of the invention, the method comprising the steps of inserting a first vent and a second vent in a glazing bar to produce a glazing bar according to claim 1.
